(19) United States
(12) Patent Application Publication
(10) Pub. No.: US 2015/0006641 A1
(43) Pub. Date: Jan. 1, 2015

(54) LOCKLESS DISTRIBUTED COUNTING OF MESSAGE REQUESTS

(71) Applicant: Apigee Corporation, San Jose, CA (US)

(72) Inventors: Vijayakumar MURUGESAN, Bangalore (IN); Vaidhyanathan Mayilrangam Gopalan, Bangalore (IN)

(73) Assignee: Apigee Corporation, Palo Alto, CA (US)

(21) Appl. No.: 13/927,119

(22) Filed: Jun. 26, 2013

(51) Int. Cl. H04L 12/58

(52) U.S. Cl. CPC H04L 51/00
USPC 709/206

(57) ABSTRACT

Lockless distributed counting of message requests. A plurality of message requests is received from a client by a plurality of message processors. A local count, for one time slot, is incremented in each message processor of the plurality of message processors based on the plurality of message requests. A global count in a shared state system, for one version, is incremented by value of the local count at a preconfigured time interval, the local count being decremented to a value zero. A global count in each message processor of the plurality of message processors is then synchronized, asynchronously, with the global count in the shared state system. The local count and the global count are subsequently reset in each message processor of the plurality of message processors to the value zero for a next time slot.

### TECHNICAL FIELD

Embodiments of the disclosure relate generally to the field of message processing systems, and more specifically, to lockless distributed counting of message requests.

### BACKGROUND

Typically, message processing systems keep count of number of message requests served for a client in a time interval and rejects one or more of the message requests if the number is higher than a preconfigured count. The message processing systems usually enforce the preconfigured count or a quota by maintaining state for the client, the state further being updated for each message request. However, when multiple message processing systems share the state for a counter, locks are applied to prevent loss of count or lost updates. Usage of the locks involves thread scheduling overhead which reduces overall throughput of a message processing system. Distributed state synchronization and quota refresh is difficult to achieve without the locks. Moreover, there is a performance drop when scalability for a group of the message processing systems is realized.

In light of the foregoing discussion, there exists a need for providing lockless distributed counting of message requests.

### SUMMARY

The above-mentioned needs are met by a method, a message processing system, and a computer program product for providing lockless distributed counting of message requests.

An example of a method of providing lockless distributed counting of message requests includes receiving a plurality of message requests from a client by a plurality of message processors. The method includes incrementing a local count, for one time slot, in each message processor of the plurality of message processors based on the plurality of message requests. The method further includes incrementing a global count in a shared state system, for one version, by value of the local count at a preconfigured time interval, the local count being decremented to a value zero. Further, the method includes synchronizing, asynchronously, a global count in each message processor of the plurality of message processors with the global count in the shared state system. Moreover, the method includes resetting the local count and the global count in each message processor of the plurality of message processors to the value zero for a next time slot.

An example of a message processing system for providing lockless distributed counting of message requests includes one or more clients, a plurality of message processors, and a shared state system. The one or more clients transmit a plurality of message requests. The plurality of message processors receive the plurality of message requests, and increment a local count, for one time slot, in each message processor of the plurality of message processors based on the plurality of message requests. The shared state system increments a global count, for one version, by value of the local count at a preconfigured time interval, wherein the local count is decremented to a value zero, and synchronizes, asynchronously, a global count in each message processor of the plurality of message processors with the global count in the shared state system.

A computer program product stored on a non-transitory computer-readable medium that when executed by a processor, performs a method of providing lockless distributed counting of message requests includes receiving a plurality of message requests from a client by a plurality of message processors. The computer program product includes incrementing a local count, for one time slot, in each message processor of the plurality of message processors based on the plurality of message requests. The computer program product further includes incrementing a global count in a shared state system, for one version, by value of the local count at a preconfigured time interval, the local count being decremented to a value zero. Further, the computer program product includes synchronizing, asynchronously, a global count in each message processor of the plurality of message processors with the global count in the shared state system. Moreover, the computer program product includes resetting the local count and the global count in each message processor of the plurality of message processors to the value zero for a next time slot.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the disclosure, the disclosure is not limited to the examples depicted in the figures.

FIG. 1 is a block diagram of a message processing system, in accordance with one embodiment;

FIG. 2 is a flow diagram illustrating a method of providing lockless distributed counting of message requests, in accordance with one embodiment; and

FIG. 3 is a block diagram of an exemplary computer system, in accordance with which various embodiments can be implemented.

### DETAILED DESCRIPTION OF THE EMBODIMENTS

The above-mentioned needs are met by a method, a message processing system, and a computer program product for providing lockless distributed counting of message requests. The following detailed description is intended to provide example implementations to one of ordinary skill in the art, and is not intended to limit the invention to the explicit disclosure, as one or ordinary skill in the art will understand that variations can be substituted that are within the scope of the invention as described.

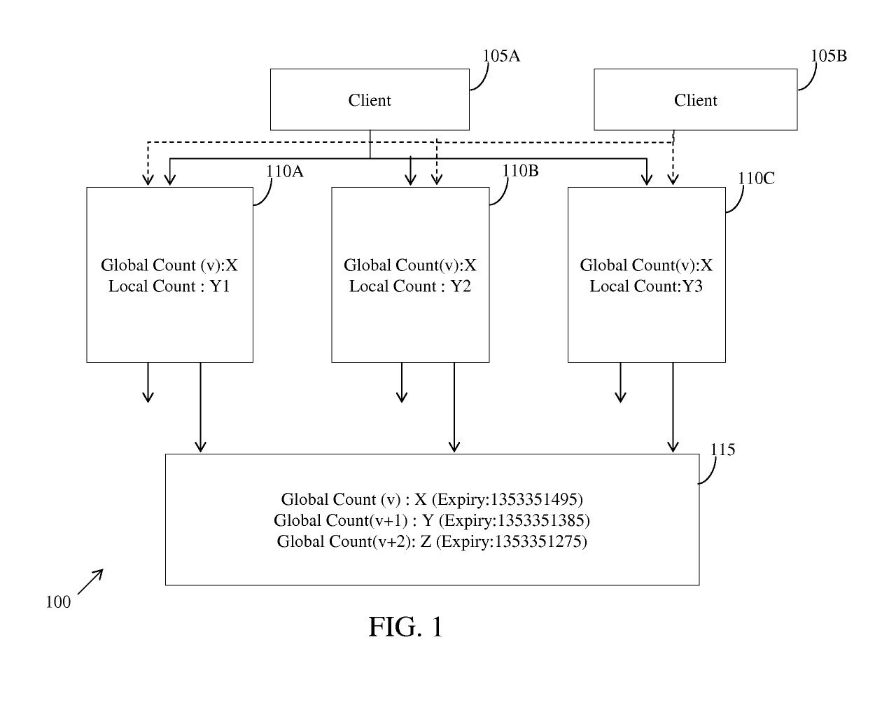

FIG. 1 is a block diagram of a message processing system 100, in accordance with one embodiment. The message processing system 100 includes one or more clients, for example a client 105A and a client 105B. The message processing system 100 also includes a plurality of message processors, for example a message processor 110A, a message processor 110B, and a message processor 110C. The message processing system 100 further includes a shared state system 115.

The message processing system 100 keeps count of a number of message requests served for a particular client, for example the client 105A, in a time interval and rejects or drops the message requests for the client 105A if the number of message requests exceed a preconfigured count or quota. A client can be defined as an application that transmits the message requests to the message processors. The message processing system 100 enforces the quota by maintaining state for each client and updating the state for each message request. The present disclosure allows the message processing system 100 to enforce the quota for the client 105A by maintaining a shared state for each client that has been served by the message processing system 100. The shared state of the client 105A is maintained in a different system, for example the shared state system 115 and the message processors synchronize corresponding states with the shared state system 115 at preconfigured time intervals. Such synchronization is performed asynchronously without affecting the latency of the message processing system 100.

The client 105A and the client 105B transmit a plurality of message requests to the message processor 110A, the message processor 110B, and the message processor 110C. Each message processor services the message requests from multiple clients.

The message processor 110A, the message processor 110B, and the message processor 110C receive the message requests from the clients, for example the client 105A. Each message processor maintains two states, namely a local count and a global count. The local count can be defined as number of the message requests served by a corresponding message processor between successive refresh of a quota. The global count can be defined as total number of the message requests served by the message processors. In one example, the message processor 110A maintains the local count as Y1, the message processor 110B maintains the local count as Y2, and the message processor 110C maintains the local count as Y3. The global count maintained in each message processor is X for a version v. Initially, the local count and the global count are a value zero as the message processors have not served the message requests from the client 105A. Based on the message requests received, the local count in each message processor is incremented for one time slot, for example a time slot between t(x−1) to tx.

In some embodiments, the local count is incremented in accordance with the quota. The quota can be defined as a sum of the local count and the global count for each message processor. The quota can be calculated at any given instant tx.

In some embodiments, one or more of the message requests are rejected if the client 105A exceeds the quota. The message requests can be rejected for the time slots t(x−1) to tx.

In some embodiments, one or more quotas are refreshed at each time interval, for example at time intervals t1, t2, t3 . . . tn, where the time intervals between t1, t2, t3 . . . tn are constant.

The shared state system 115 maintains a shared state for multiple versions, for example the versions 1 . . . v, of a global count along with corresponding expiry time. In one example, the shared state system 115 maintains the shared state for the version v having an expiry time as 1353351495 seconds. The shared state system 115 increments the global count, for the version v, by value of the local count at a preconfigured time interval. The global count is incremented by one of multiple threads in the message processor 110A. The local count is subsequently decremented to the value zero. The global count in the message processor 110B and the message processor 110C is then synchronized, asynchronously, with the global count in the shared state system 115. In other examples, the shared state system 115 also maintains the shared state for the version v+1 having an expiry time as 1353351385 seconds, and for the version v+2 having an expiry time as 1353351275 seconds.

In some embodiments, the shared state system 115 includes expiry time for the versions of the global count in order to synchronize the global count for the message processors joining a cluster of message processors, if the expiry time of a previous version is less than a current system time.

In some embodiments, the global count is asynchronously synchronized from the message processors and the shared state system 115 in a different thread that does not service the message requests for the client 105A.

The message processing system 100 further resets the local count and the global count in each message processor to the value zero for a next time slot, for example the time slot between tx to t(x+1). The shared state system 115 then updates the global count for a next version v+1. The version v of the global count is removed once the message processors update the local count and the global count for the version v+1.

As synchronization occurs asynchronously and the quota is calculated from the local count, latency is not affected for the message processors. State change for the local count in each message processor is carried out by either incrementing or decrementing the local count, hence there is no overwriting or loss of update when multiple threads concurrently updates a state.

TABLE 1
State of components at different quota intervals

| Compo- | | | | | |
|---|---|---|---|---|---|
| nents | t0-t1 | t1 | t1-t2 | t2 | t2-t3 |
| Message | Global | Global | Global | Global | Global |
| Processor | count: p | count: 0 | count: q | count: 0 | count: r |
| 110A | Local | Local | Local | Local | Local |
| | count: x1 | count: 0 | count: y1 | count: 0 | count: z1 |
| Message | Global | Global | Global | Global | Global |
| Processor | count: p | count: 0 | count: q | count: 0 | count: r |
| 110B | Local | Local | Local | Local | Local |
| | count: x2 | count: 0 | count: y2 | count: 0 | count: z2 |
| Message | Global | Global | Global | Global | Global |
| Processor | count: p | count: 0 | count: q | count: 0 | count: r |
| 110C | Local | Local | Local | Local | Local |
| | count: x3 | count: 0 | count: y3 | count: 0 | count: z3 |
| Shared | Global | | Global | | Global |
| State | count(1): p | | count(2): q | | count(3): r |
| System | Expiry | | Expiry | | Expiry |
| 115 | time: t1 | | time: t2 | | time: t3 |
| | | | Local Count | | Local Count |
| | | | [Discard the | | [Discard the |
| | | | state entry | | state entry |
| | | | Global | | Global |
| | | | Count | | Count |
| | | | (1)] | | (2)] |

Table 1 illustrated above provides state of components at different quota intervals, for example t1, t2 and t3. The components include the message processor 110A, the message processor 110B, the message processor 110C, and the shared state system 115. At a time slot t0-t1, the message processor 110A has a global count as p and a local count as x1, the message processor 110B has a global count as p and a local count as x2, the message processor 110B has a global count as p and a local count as x3, and the shared state system 115 has a global count (1) as p and an expiry time as t1. For the next time slot t1, the global count and the local count of the message processors are reset to the value zero. Similarly, at a time slot t1-t2, the message processor 110A has a global count as q and a local count as y1, the message processor 110B has a global count as q and a local count as y2, the message processor 110B has a global count as q and a local count as y3, and the shared state system 115 has a global count (2) as q and an expiry time as t2. The global count (1) is discarded. For the next time slot t2, the global count and the local count of the message processors are reset to the value zero. At a time slot t2-t3, the message processor 110A has a global count as r and a local count as z1, the message processor 110B has a global count as r and a local count as z2, the message processor 110B has a global count as r and a local count as z3, and the shared state system 115 has a global count (3) as r and an expiry time as t3. The global count (2) is discarded.

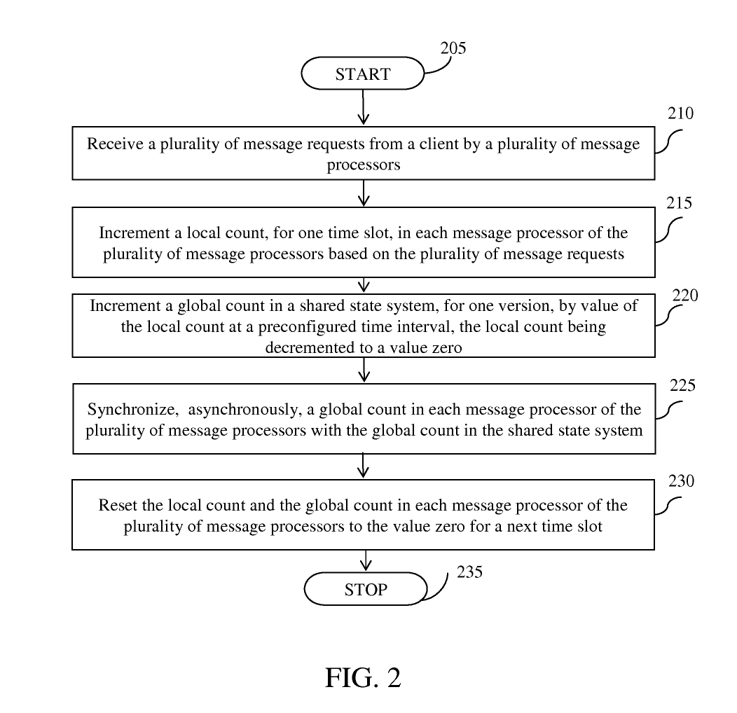

FIG. 2 is a flow diagram illustrating a method of providing lockless distributed counting of message requests, in accordance with one embodiment. The method starts at step 205.

At step 210, a plurality of message requests is received from a client, for example the client 105A, by a plurality of message processors, for example the message processor 110A, the message processor 110B, and the message processor 110C.

In some embodiments, each message processor serves the message requests from a plurality of clients.

At step 215, a local count, for one time slot, is incremented in each message processor of the message processors based on the message requests.

In some embodiments, the local count is incremented in accordance with a quota. The quota can be defined as a sum of the local count and the global count in each message processor.

At step 220, a global count in a shared state system, for example the shared state system 115, for one version, is incremented by value of the local count at a preconfigured time interval. The local count is decremented to a value zero. A shared state is maintained for a plurality of versions of the global count along with corresponding expiry time in the shared state system.

Both the local count and the global count are maintained in each message processor.

In some embodiments, one or more of the message requests are rejected if the client exceeds the quota.

In some embodiments, one or more quotas are refreshed at each time interval.

At step 225, a global count in each message processor is asynchronously synchronized with the global count in the shared state system.

At step 230, the local count and the global count in each message processor is reset to the value zero for a next time slot. The global count in the shared state system is then updated for a next version.

The method stops at step 235.

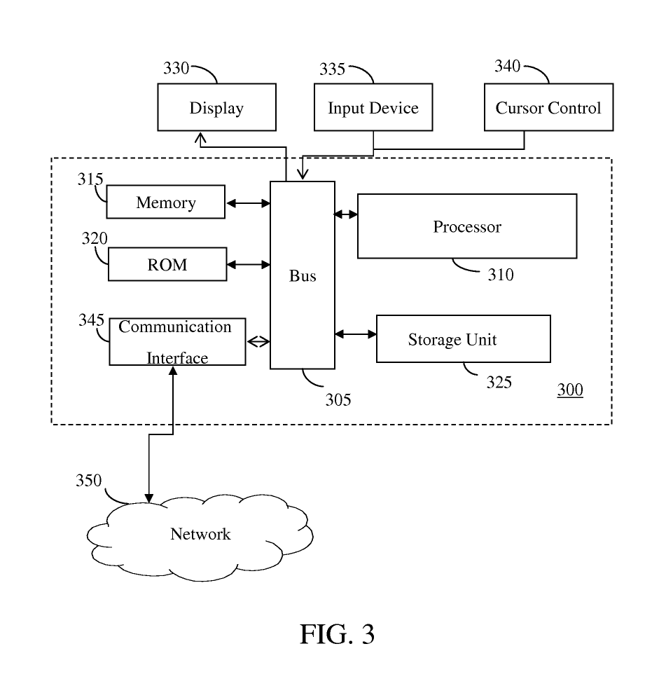

FIG. 3 is a block diagram of an exemplary computer system 300, in accordance with which various embodiments can be implemented.

The computer system 300 includes a bus 305 or other communication mechanism for communicating information, and a processor 310 coupled with the bus 305 for processing information. The computer system 300 also includes a memory 315, for example a random access memory (RAM) or other dynamic storage device, coupled to the bus 305 for storing information and instructions to be executed by the processor 310. The memory 315 can be used for storing temporary variables or other intermediate information during execution of instructions by the processor 310. The computer system 300 further includes a read only memory (ROM) 320 or other static storage device coupled to the bus 305 for storing static information and instructions for the processor 310. A storage unit 325, for example a magnetic disk or optical disk, is provided and coupled to the bus 305 for storing information.

The computer system 300 can be coupled via the bus 305 to a display 330, for example a cathode ray tube (CRT), and liquid crystal display (LCD) for displaying information to a user. An input device 335, including alphanumeric and other keys, is coupled to the bus 305 for communicating information and command selections to the processor 310. Another type of user input device is a cursor control 340, for example a mouse, a trackball, or cursor direction keys for communicating direction information and command selections to the processor 310 and for controlling cursor movement on the display 330. The input device 335 can also be included in the display 330, for example a touch screen.

Various embodiments are related to the use of the computer system 300 for implementing the techniques described herein. In some embodiments, the techniques are performed by the computer system 300 in response to the processor 310 executing instructions included in the memory 315. Such instructions can be read into the memory 315 from another machine-readable medium, for example the storage unit 325. Execution of the instructions included in the memory 315 causes the processor 310 to perform the process steps described herein.

In some embodiments, the processor 310 can include one or more processing units for performing one or more functions of the processor 310. The processing units are hardware circuitry used in place of or in combination with software instructions to perform specified functions.

The term “machine-readable medium” as used herein refers to any medium that participates in providing data that causes a machine to perform a specific function. In an embodiment implemented using the computer system 300, various machine-readable media are involved, for example, in providing instructions to the processor 310 for execution. The machine-readable medium can be a storage medium, either volatile or non-volatile. A volatile medium includes, for example, dynamic memory, for example the memory 315. A non-volatile medium includes, for example, optical or magnetic disks, for example the storage unit 325. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 305. Transmission media can also take the form of acoustic or light waves, for example those generated during radio-wave and infra-red data communications. Examples of machine-readable media can include, but are not limited to, a carrier wave as described hereinafter or any other media from which the computer system 300 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the computer system 300 can receive the data on the telephone line and use an infra-red transmitter to convert the data to an infra-red signal. An infra-red detector can receive the data carried in the infra-red signal and appropriate circuitry can place the data on the bus 305. The bus 305 carries the data to the memory 315, from which the processor 310 retrieves and executes the instructions. The instructions received by the memory 315 can optionally be stored on the storage unit 325 either before or after execution by the processor 310. All such media must be tangible to enable the instructions carried by the media to be detected by a physical mechanism that reads the instructions into a machine.

The computer system 300 also includes a communication interface 345 coupled to the bus 305. The communication interface 345 provides a two-way data communication coupling to the network 350. For example, the communication interface 345 can be an integrated services digital network (ISDN) card or a modem to provide a data communication connection to a corresponding type of telephone line. As another example, the communication interface 345 can be a local area network (LAN) card to provide a data communication connection to a compatible LAN. Wireless links can also be implemented. In any such implementation, the communication interface 345 sends and receives electrical, electromagnetic or optical signals that carry digital data streams representing various types of information.

The present disclosure provides lockless distributed counting of message requests. The present disclosure allows scalable state synchronization for counter, and also implements a time-stamped version control state maintenance to facilitate fault tolerance where any of the message processing systems can switch between on and off states without missing synchronization cycle for distributed count. The present disclosure further guarantees high-availability of the counter provided the shared state system is clustered and highly available. The present disclosure can also handle quota count for non-positive values.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of providing lockless distributed counting of message requests, the method comprising:
receiving a plurality of message requests from a client by a plurality of message processors;
incrementing a local count, for one time slot, in each message processor of the plurality of message processors based on the plurality of message requests;
incrementing a global count in a shared state system, for one version, by value of the local count at a preconfigured time interval, wherein the local count is decremented to a value zero;
synchronizing, asynchronously, a global count in each message processor of the plurality of message processors with the global count in the shared state system; and
resetting the local count and the global count in each message processor of the plurality of message processors to the value zero for a next time slot.

2. The method as claimed in claim 1, wherein each message processor of the plurality of message processors serves the plurality of message requests from a plurality of clients.

3. The method as claimed in claim 1 and further comprising
maintaining the local count and the global count in each message processor of the plurality of message processors.

4. The method as claimed in claim 1 and further comprising
maintaining a shared state for a plurality of versions of the global count along with corresponding expiry time in the shared state system.

5. The method as claimed in claim 1 and further comprising
incrementing the local count in accordance with a quota, wherein the quota is a sum of the local count and the global count in each message processor of the plurality of message processors.

6. The method as claimed in claim 4, wherein one or more of the plurality of message requests are rejected if the client exceeds the quota.

7. The method as claimed in claim 1, wherein resetting the local count and the global count comprises:
updating the global count in the shared state system for a next version.

8. The method as claimed in claim 1 and further comprising
refreshing one or more quotas at each time interval.

9. A message processing system for providing lockless distributed counting of message requests, the message processing system comprising:
one or more clients that transmit a plurality of message requests;
a plurality of message processors that
receive the plurality of message requests, and
increment a local count, for one time slot, in each message processor of the plurality of message processors based on the plurality of message requests, and a shared state system that
increments a global count, for one version, by value of the local count at a preconfigured time interval, wherein the local count is decremented to a value zero, and
synchronizes, asynchronously, a global count in each message processor of the plurality of message processors with the global count in the shared state system.

10. The message processing system as claimed in claim 9, wherein the message processing system resets the local count and the global count in each message processor of the plurality of message processors to the value zero for a next time slot.

11. The message processing system as claimed in claim 9, wherein each message processor of the plurality of message processors serves the plurality of message requests from a plurality of clients.

12. The message processing system as claimed in claim 9, wherein each message processor of the plurality of message processors maintains the local count and the global count.

13. The message processing system as claimed in claim 9, wherein the shared state system maintains a shared state for a plurality of versions of the global count along with corresponding expiry time.

14. A computer program product stored on a non-transitory computer-readable medium that when executed by a processor, performs a method of providing lockless distributed counting of message requests, comprising:
receiving a plurality of message requests from a client by a plurality of message processors;
incrementing a local count, for one time slot, in each message processor of the plurality of message processors based on the plurality of message requests;
incrementing a global count in a shared state system, for one version, by value of the local count at a preconfigured time interval, wherein the local count is decremented to a value zero;
synchronizing, asynchronously, a global count in each message processor of the plurality of message processors with the global count in the shared state system; and
resetting the local count and the global count in each message processor of the plurality of message processors to the value zero for a next time slot.

15. The computer program product as claimed in claim 14, wherein each message processor of the plurality of message processors serves the plurality of message requests from a plurality of clients.

16. The computer program product as claimed in claim 14 and further comprising
maintaining the local count and the global count in each message processor of the plurality of message processors.

17. The computer program product as claimed in claim 14 and further comprising
maintaining a shared state for a plurality of versions of the global count along with corresponding expiry time in the shared state system.

18. The computer program product as claimed in claim 14 and further comprising
incrementing the local count in accordance with a quota, wherein the quota is a sum of the local count and the global count in each message processor of the plurality of message processors.

19. The computer program product as claimed in claim 18, wherein one or more of the plurality of message requests are rejected if the client exceeds the quota.

20. The computer program product as claimed in claim 14, wherein resetting the local count and the global count comprises:
updating the global count in the shared state system for a next version.

21. The computer program product as claimed in claim 14 and further comprising refreshing one or more quotas at each time interval.
